(19) United States
(12) Patent Application Publication
(10) Pub. No.: US 2023/0341594 A1
(43) Pub. Date: Oct. 26, 2023

(54) SPATIALLY SELECTIVE TINTING ARCHITECTURE FOR HEAD-WORN DEVICES

(71) Applicant: GOOGLE LLC, Mountain View, CA (US)

(72) Inventor: Joseph Daniel Lowney, Tucson, AZ (US)

(21) Appl. No.: 18/137,393

(22) Filed: Apr. 20, 2023

Related U.S. Application Data
(60) Provisional application No. 63/332,826, filed on Apr. 20, 2022.

(51) Int. Cl. G02B 5/00; G02B 27/01

(52) U.S. Cl. CPC G02B 5/005; G02B 27/0172; G02B 2027/0178; G02B 2027/0118; G02B 2027/0123

(57) ABSTRACT

To help reduce glints in head-worn device (HWD), a HWD includes a spatially selective tinting architecture. To this end, the HWD includes a frame to be worn by a user. Further, the HWD includes a first lens that has a first portion including a tint configured to block at least a portion of ambient light and a second portion including an aperture. Additionally, the HWD includes a waveguide having an outcoupler configured to provide light to the aperture of the first lens. The first lens and waveguide are aligned such that a portion of ambient light from outside the HWD is blocked before reaching the user while light from the waveguide passes through to the user unattenuated.

### CROSS-REFERENCE TO RELATED APPLICATIONS

The present application claims priority to U.S. Provisional Patent Application Ser. No. 63/332,826, entitled “SPATIALLY SELECTIVE TINTING ARCHITECTURE FOR HEAD-WORN DEVICES” and filed on Apr. 20, 2022, the entirety of which is incorporated by reference herein.

### BACKGROUND

Within some head-mounted displays, waveguides are used to guide light from an optical engine to the eye of a user in order to display one or more images to the user. To this end, these waveguides commonly are formed from materials that are at least partially reflective such as high-index glass or high-index optical plastics. Additionally, such waveguides typically have a planar shape that includes two opposing flat surfaces. Due to the materials and the planar shape of these waveguides, ambient light (e.g., sunlight, indoor lighting, outdoor lighting) from outside the HWD commonly reflects off the surfaces of the waveguides either toward the user or toward those around the user, creating a jarring experience for both the user and those around them and negatively impacting the user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a diagram of an example display system housing a laser projector system configured to project images toward the eye of a user, in accordance with some embodiments.

FIG. 2 is a diagram illustrating a laser projection system that projects images directly onto the eye of a user via laser light, in accordance with some embodiments.

FIG. 3 is a diagram illustrating an example waveguide exit pupil expansion system, in accordance with embodiments.

FIG. 4 is a diagram illustrating a partially transparent view of a head-worn display (HWD) that includes a laser projection system, in accordance with some embodiments.

FIG. 5 is a block diagram of a tinting architecture for an optical combiner, in accordance with some embodiments.

FIG. 6 is a block diagram of a tinting architecture for an optical combiner configured to reduce glints, in accordance with some embodiments.

FIG. 7 is a block diagram of a spatially selective tinting architecture for an optical combiner, in accordance with some embodiments.

FIG. 8 is an isometric view of a spatially selective tinting architecture, in accordance with some embodiments.

### DETAILED DESCRIPTION

Some head-worn displays (HWDs) (e.g., augmented reality head-worn displays) are designed to look like eyeglasses, with at least one of the lenses containing a waveguide to direct light to a user's eye. The combination of the lens and waveguide is referred to as an “optical combiner,” “optical combiner lens,” or both. Such waveguides form, for example, exit pupil expanders (EPEs) and outcouplers that form and guide light to the user's eye. For example, a waveguide forms an outcoupler configured to direct received light toward the eye of a user. The HWDs generally have a frame designed to be worn in front of a user's eyes to allow the user to view both their environment and computer-generated content projected from the combiner. Components that are necessary to the functioning of a typical HWDs, such as, for example, an optical engine to project computer-generated content (e.g., light representative of one or more images), cameras to pinpoint physical location, cameras to track the movement of the user's eye(s), processors to power the optical engine, and a power supply, are typically housed within the frame of the HWD. As an HWD frame has limited volume in which to accommodate these components, it is desirable that these components be as small as possible and configured to interact with the other components in very small volumes of space.

Further, some HWDs include waveguides having a surface that is at least partially reflective. For example, some waveguides include surfaces formed from plastic molded parts, plastic-formed parts, plastic embossed parts, glass, high-index glass or the like that are at least partially reflective. Because the surface of some waveguides is at least partially reflective, ambient light (e.g., sunlight, indoor lighting) from outside an HWD commonly reflects off the surface of the waveguide toward the eye of a user, creating a glint that negatively impacts the user experience. As an example, such glints are distracting to the user of the HWD and those around the user of the HWD, negatively impacting the user experience. To help minimize such glints, a spatially selective tinting architecture is implemented in the HWD. The spatially selective tinting architecture is configured to be implemented in an HWD and includes an optical combiner having a waveguide disposed between a first lens and a second lens. A first portion of the first lens includes a tint (e.g., a tinting film) that tints the first portion of the first lens and a second portion of the first tinted lens includes an aperture configured to allow light provided from a waveguide to pass through unimpeded on its way to the eye of a user. The second lens of the optical combiner includes a first portion lacking a tint so as to allow ambient light to pass through unimpeded and a second portion including a tinted region complementary to the aperture. Further, within the optical combiner, the first lens, waveguide, and second lens are aligned such that the second portion of the first lens (e.g., the aperture), outcoupler of the waveguide, and the second portion of the second lens (e.g., the tinted region) are aligned. As an example, the first lens, waveguide, and second lens are aligned so as to allow light provided from the waveguide to pass through the aperture of the first lens unfiltered. As another example, the first lens, waveguide, and second lens are aligned so as to prevent ambient light received at the second lens from passing to the aperture of the first lens. Because the spatially selective tinting architecture allows light provided from the waveguide to pass through the first lens while still blocking ambient light, glints directed to the eye of a user are reduced without also filtering (e.g., attenuating) the light provided from the waveguide. Additionally, because the first lens, waveguide, and second lens are aligned, the tinting of the HWD appears effectively uniform to onlookers (e.g., the tinting appears to have no gaps to onlookers).

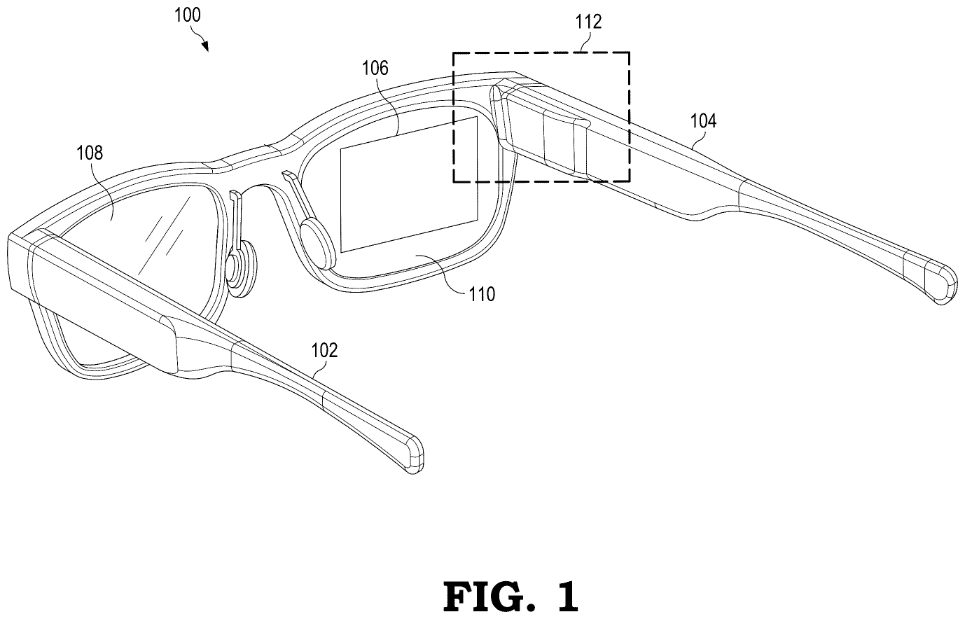

FIG. 1 illustrates an example display system 100 having a support structure 102 that includes an arm 104, which houses a laser projection system configured to project images toward the eye of a user, such that the user perceives the projected images as being displayed in a field of view (FOV) area 106 of a display at one or both of lens elements 108, 110. In the depicted embodiment, the display system 100 is an eyewear display that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a laser projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth(™) interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, laser light used to form a perceptible image or series of images may be projected by a laser projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a digital light processing-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, an optical relay disposed between the first and second scan mirrors, and a waveguide disposed at the output of the second scan mirror. In some embodiments, at least a portion of an outcoupler of the waveguide may overlap the FOV area 106. These aspects are described in greater detail below.

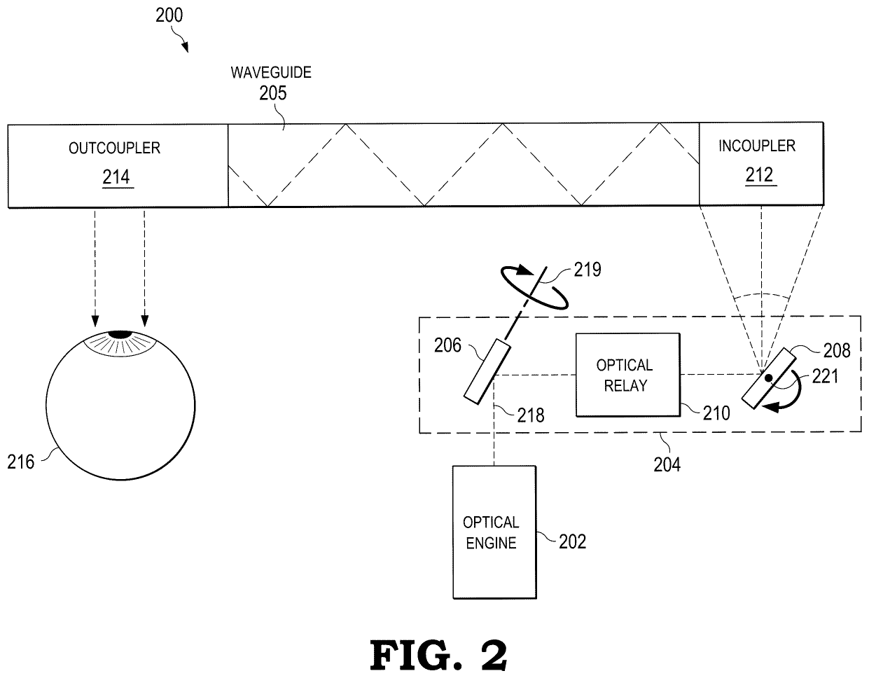

FIG. 2 illustrates a simplified block diagram of a laser projection system 200 that projects images directly onto the eye of a user via laser light. The laser projection system 200 includes an optical engine 202, an optical scanner 204, and a waveguide 205. The optical scanner 204 includes a first scan mirror 206, a second scan mirror 208, and an optical relay 210. The waveguide 205 includes an incoupler 212 and an outcoupler 214, with the outcoupler 214 being optically aligned with an eye 216 of a user in the present example. In some embodiments, the laser projection system 200 is implemented in a wearable heads-up display or other display system, such as the display system 100 of FIG. 1.

The optical engine 202 includes one or more laser light sources configured to generate and output laser light 218 (e.g., visible laser light such as red, blue, and green laser light and/or non-visible laser light such as infrared laser light). In some embodiments, the optical engine 202 is coupled to a driver or other controller (not shown), which controls the timing of emission of laser light from the laser light sources of the optical engine 202 in accordance with instructions received by the controller or driver from a computer processor coupled thereto to modulate the laser light 218 to be perceived as images when output to the retina of an eye 216 of a user.

For example, during the operation of the laser projection system 200, multiple laser light beams having respectively different wavelengths are output by the laser light sources of the optical engine 202, then combined via a beam combiner (not shown), before being directed to the eye 216 of the user. The optical engine 202 modulates the respective intensities of the laser light beams so that the combined laser light reflects a series of pixels of an image, with the particular intensity of each laser light beam at any given point in time contributing to the amount of corresponding color content and brightness in the pixel being represented by the combined laser light at that time.

One or both of the scan mirrors 206 and 208 of the optical scanner 204 are MEMS mirrors in some embodiments. For example, the scan mirror 206 and the scan mirror 208 are MEMS mirrors that are driven by respective actuation voltages to oscillate during active operation of the laser projection system 200, causing the scan mirrors 206 and 208 to scan the laser light 218. Oscillation of the scan mirror 206 causes laser light 218 output by the optical engine 202 to be scanned through the optical relay 210 and across a surface of the second scan mirror 208. The second scan mirror 208 scans the laser light 218 received from the scan mirror 206 toward an incoupler 212 of the waveguide 205. In some embodiments, the scan mirror 206 oscillates along a first scanning axis 219, such that the laser light 218 is scanned in only one dimension (i.e., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 212 has a substantially rectangular profile and is configured to receive the laser light 218 and direct the laser light 218 into the waveguide 205. The incoupler 212 is defined by a smaller dimension (i.e., width) and a larger orthogonal dimension (i.e., length). In an embodiment, the optical relay 210 is a line-scan optical relay that receives the laser light 218 scanned in a first dimension by the first scan mirror 206 (e.g., the first dimension corresponding to the small dimension of the incoupler 212), routes the laser light 218 to the second scan mirror 208, and introduces a convergence to the laser light 218 in the first dimension to an exit pupil beyond the second scan mirror 208. Herein, an “exit pupil” in an optical system refers to the location along the optical path where beams of light intersect. For example, the possible optical paths of the laser light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the laser light corresponding to that exit pupil. Accordingly, the exit pupil can be considered a “virtual aperture”. According to various embodiments, the optical relay 210 includes one or more collimation lenses that shape and focus the laser light 218 on the second scan mirror 208 or includes a molded reflective relay that includes two or more spherical, aspheric, parabolic, and/or freeform lenses that shape and direct the laser light 218 onto the second scan mirror 208. The second scan mirror 208 receives the laser light 218 and scans the laser light 218 in a second dimension, the second dimension corresponding to the long dimension of the incoupler 212 of the waveguide 205. In some embodiments, the second scan mirror 208 causes the exit pupil of the laser light 218 to be swept along a line along the second dimension. In some embodiments, the incoupler 212 is positioned at or near the swept line downstream from the second scan mirror 208 such that the second scan mirror 208 scans the laser light 218 as a line or row over the incoupler 212.

In some embodiments, the optical engine 202 includes an edge-emitting laser (EEL) that emits a laser light 218 having a substantially elliptical, non-circular cross-section, and the optical relay 210 magnifies or minimizes the laser light 218 along its semi-major or semi-minor axis to circularize the laser light 218 prior to convergence of the laser light 218 on the second scan mirror 208. In some such embodiments, a surface of a mirror plate of the scan mirror 206 is elliptical and non-circular (e.g., similar in shape and size to the cross-sectional area of the laser light 218). In other such embodiments, the surface of the mirror plate of the scan mirror 206 is circular.

The waveguide 205 of the laser projection system 200 includes the incoupler 212 and the outcoupler 214. The term “waveguide,” as used herein, will be understood to mean a combiner using one or more of total internal reflection (TIR), specialized filters, and/or reflective surfaces, to transfer light from an incoupler (such as the incoupler 212) to an outcoupler (such as the outcoupler 214). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the laser light 218 received at the incoupler 212 is relayed to the outcoupler 214 via the waveguide 205 using TIR. The laser light 218 is then output to the eye 216 of a user via the outcoupler 214. As described above, in some embodiments the waveguide 205 is implemented as part of an eyeglass lens, such as the lens 108 or lens 110 (FIG. 1) of the display system having an eyeglass form factor and employing the laser projection system 200.

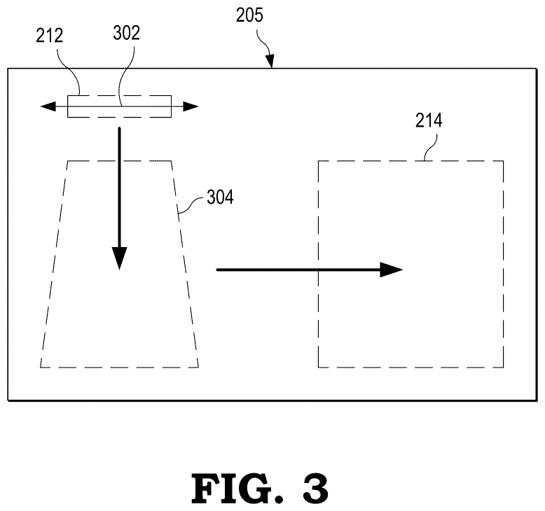

Although not shown in the example of FIG. 2, in some embodiments additional optical components are included in any of the optical paths between the optical engine 202 and the scan mirror 206, between the scan mirror 206 and the optical relay 210, between the optical relay 210 and the scan mirror 208, between the scan mirror 208 and the incoupler 212, between the incoupler 212 and the outcoupler 214, and/or between the outcoupler 214 and the eye 216 (e.g., in order to shape the laser light for viewing by the eye 216 of the user). In some embodiments, a prism is used to steer light from the scan mirror 208 into the incoupler 212 so that light is coupled into incoupler 212 at the appropriate angle to encourage propagation of the light in waveguide 205 by TIR. Also, in some embodiments, an exit pupil expander (e.g., an exit pupil expander 304 of FIG. 3, described below), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the laser light out of waveguide 205 (e.g., toward the eye 216 of the user).

FIG. 3 shows an example of light propagation within the waveguide 205 of the laser projection system 200 of FIG. 2 in accordance with some embodiments. As shown, light received via the incoupler 212, which is scanned along the scanning axis 302, is directed into an exit pupil expander (EPE) 304 and is then routed to the outcoupler 214 to be output (e.g., toward the eye of the user). In some embodiments, the exit pupil expander 304 expands one or more dimensions of the eyebox of a WHUD that includes the laser projection system 200 (e.g., with respect to what the dimensions of the eyebox of the WHUD would be without the exit pupil expander 304). In some embodiments, the incoupler 212 and the exit pupil expander 304 each include respective one-dimensional diffraction gratings (i.e., diffraction gratings that extend along one dimension). It should be understood that FIG. 3 shows a substantially ideal case in which the incoupler 212 directs light straight down (with respect to the presently illustrated view) in a first direction that is perpendicular to the scanning axis 302, and the exit pupil expander 304 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

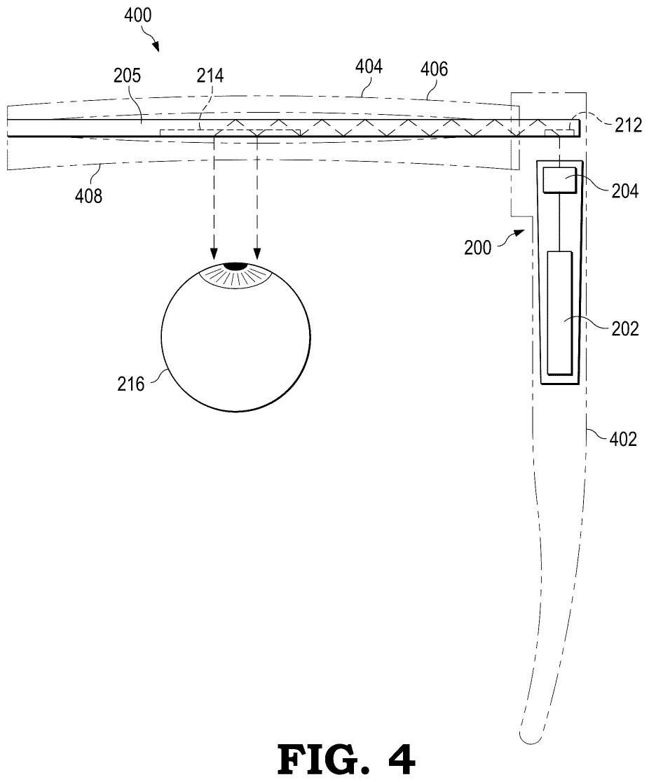

FIG. 4 illustrates a portion of an eyewear display 400 that includes the laser projection system 200 of FIG. 2. In some embodiments, the eyewear display 400 represents the display system 100 of FIG. 1. The optical engine 202, the optical scanner 204, the incoupler 212, and a portion of the waveguide 205 are included in an arm 402 of the eyewear display 400, in the present example.

The eyewear display 400 includes an optical combiner lens 404, which includes a first lens 406, a second lens 408, and the waveguide 205, with the waveguide 205 disposed between the first lens 406 and the second lens 408. Light exiting through the outcoupler 214 travels through the second lens 408 (which corresponds to, for example, the lens element 110 of the display system 100). In use, the light exiting second lens 408 enters the pupil of an eye 216 of a user wearing the eyewear display 400, causing the user to perceive a displayed image carried by the laser light output by the optical engine 202. The optical combiner lens 404 is substantially transparent, such that light from real-world scenes corresponding to the environment around the eyewear display 400 passes through the first lens 406, the second lens 408, and the waveguide 205 to the eye 216 of the user. In this way, images or other graphical content output by the laser projection system 200 are combined (e.g., overlayed) with real-world images of the user's environment when projected onto the eye 216 of the user to provide an AR experience to the user.

Although not shown in the depicted example, in some embodiments additional optical elements are included in any of the optical paths between the optical engine 202 and the incoupler 212, in between the incoupler 212 and the outcoupler 214, and/or in between the outcoupler 214 and the eye 216 of the user (e.g., in order to shape the laser light for viewing by the eye 216 of the user). As an example, a prism is used to steer light from the optical scanner 204 into the incoupler 212 so that light is coupled into incoupler 212 at the appropriate angle to encourage propagation of the light in waveguide 205 by TIR. Also, in some embodiments, an exit pupil expander (e.g., the exit pupil expander 304), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the laser light out of waveguide 205 (e.g., toward the eye 216 of the user).

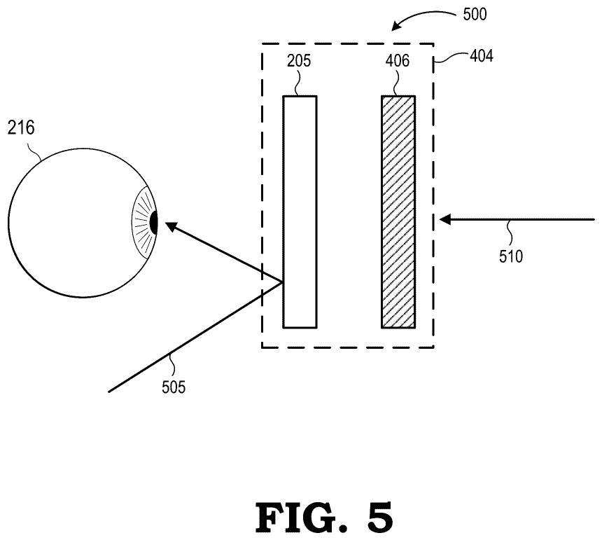

Additionally, in some embodiments, optical combiner lens 404 is configured to filter at least a portion of ambient light from, for example, sunlight, indoor lighting, outdoor lighting, or the like received from outside eyewear display 400. As an example, optical combiner lens 404 is configured to filter at least a portion of ambient light received from outside eyewear display 400 before the portion of ambient light reaches the eye 216 of a user. To this end, FIG. 5 illustrates a tinting architecture 500, according to embodiments. According to some embodiments, tinting architecture 500 is implemented within optical combiner lens 404 to filter at least a portion of ambient light 510 received from outside an HWD (e.g. eyewear display 400). Within tinting architecture 500, optical combiner lens 404 includes waveguide 205 disposed between a first lens 406 and the eye 216 of a user. First lens 406, for example, includes a plastic lens, a glass lens, a polycarbonate lens, or any combination thereof. Additionally, in embodiments, first lens 406 includes one or more coatings disposed on a surface of the first lens 406, such as, a mirror coating, anti-reflective coating, scratch-resistant coating, anti-fog coating, ultraviolet treatment, blue light coating, or any combination thereof. To protect the eye 216 of a user from ambient light 510 (e.g., sunlight), first lens 406 includes one or more tints configured to filter at least a portion of ambient light 510. As an example, first lens 406 includes one or more lenses, dyes, films, coatings, or any combination thereof that provide a gray tint, brown tint, amber tint, green tint, yellow tint, blue tint, red tint, or any combination thereof configured to filter at least a portion of ambient light 510 before the ambient light 510 reaches the eye 216 of the user. In embodiments, first lens 406 is configured to filter at least a portion of ambient light 510 based on a color of the tint of the first lens. That is to say, based on the tint of first lens 406, first lens 406 is configured to filter, reduce, or both one or more wavelengths of light of ambient light 510.

However, according to some embodiments, waveguide 205 includes surfaces formed from plastic molded parts, plastic formed parts, plastic embossed parts, glass, high-index glass, or the like that are at least partially reflective. Because the surfaces of waveguide 205 are at least partially reflective, additional ambient light from outside an HWD (e.g., eyewear display 400) reflects off the waveguide 205 as stray light 505. Such stray light 505, for example, represents an amount of ambient light reflected off a surface of the waveguide 205 and towards the eye 216 of a user. In embodiments, once stray light 505 reflects off waveguide 205 towards the eye 216 of a user, a glint (e.g., reflection or flash of light) off waveguide 205 occurs, creating a jarring experience for the user and those around the user and decreasing user experience.

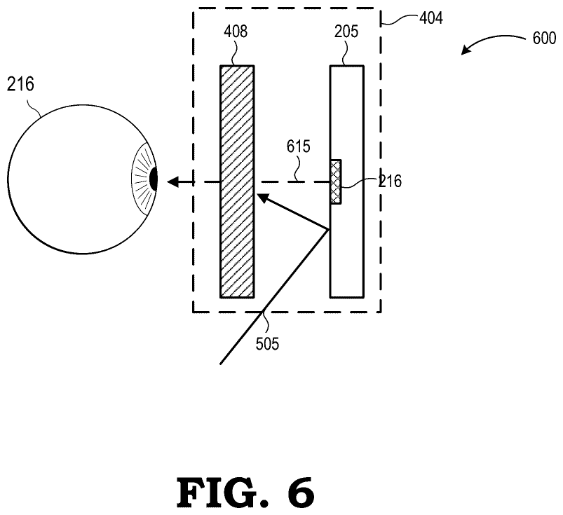

As such, FIG. 6, presents a tinting architecture 600 for optical combiner lens 404 configured to reduce glints from stray light. Within tinting architecture 600, optical combiner lens 404 includes a second lens 408 disposed between the eye 216 of a user and waveguide 205. Second lens 408 includes, for example, a plastic lens, a glass lens, a polycarbonate lens, or any combination thereof. Additionally, in embodiments, second lens 408 includes one or more coatings disposed on a surface of the second lens 408, such as, a mirror coating, anti-reflective coating, scratch-resistant coating, anti-fog coating, ultraviolet treatment, blue light coating, or any combination thereof. Further, within tinting architecture 600, waveguide includes one or more surfaces (e.g., formed from plastic molded parts, plastic formed parts, plastic embossed parts, glass, high-index glass, or any combination thereof) configured to at least partially reflect ambient light towards the eye 216 of the user as stray light 505. To help prevent stray light 505 (e.g., any glints created by stray light from 505) from reaching the eye 216 of the user, second lens 408 includes one or more tints configured to filter at least a portion of stray light 505. As an example, second lens 408 includes one or more lenses, dyes, films, coatings, or any combination thereof that provide a gray tint, brown tint, amber tint, green tint, yellow tint, blue tint, red tint, or any combination thereof configured to filter at least a portion of stray light 505 before the stray light 505 reaches the eye 216 of the user. According to some embodiments, second lens 408 is configured to filter at least a portion of stray light 505 based on a color of the tint of the second lens 408. In other words, based on the tint of second lens 408, second lens 408 is configured to filter, reduce, or both one or more wavelengths of light of stray light 505.

In this way, second lens 408 is configured to filter at least a portion of stray light 505 based on one or more tints before stray light 505 (e.g., one or more glints caused by stray light 505) is received by the eye 216 of the user. Because stray light 505 is at least partially filtered before reaching the eye 216 of the user, the number of glints seen by the user is reduced, improving user experience. However, in some embodiments, the waveguide 205 includes outcoupler 214 configured to direct received light (e.g., light received from an optical engine 204) to the eye 216 of a user as output light 615. Further, according to embodiments, output light 615 passes through the second lens 408 before being received by the eye 216 of the user. As output light 615 passes through the second lens 408, the second lens 408 filters at least a portion of output light 615 based on a tint of the second lens 408 before output light 615 is provided to the eye 216 of a user. Because the second lens 408 filters output light 615 before output light 615 is received by the eye 216 of a user, the brightness of the displayed image represented by output light 615 is, in some embodiments, reduced, diminishing the quality of the displayed image and negatively impacting user experience.

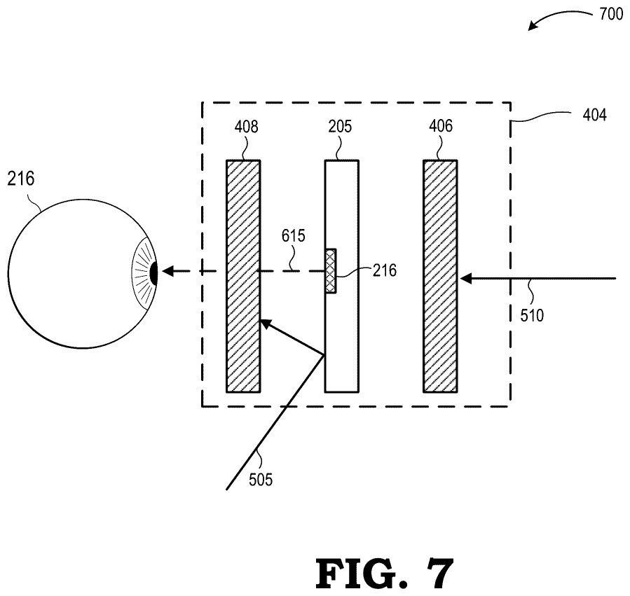

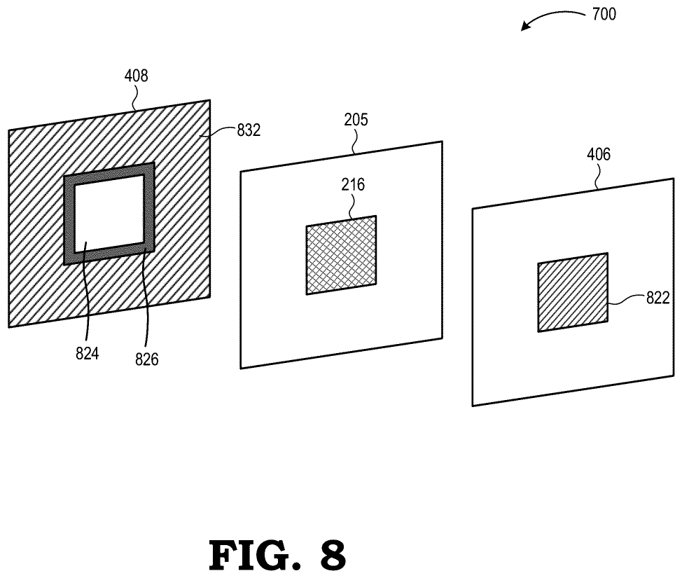

To help prevent the brightness of the displayed image represented by output light 615 from being reduced, FIGS. 7 and 8 both present a spatially selective tinting architecture 700 for an optical combiner lens. In embodiments, spatially selective tinting architecture is implemented in optical combiner lens 404. Referring now to FIG. 7, within optical combiner lens 404, spatially selective tinting architecture 700 includes waveguide 205 disposed between the first lens 406 and the second lens 408. At least a portion of the first lens 406 and at least a portion of the second lens 408 each include one or more lenses, dyes, films, coatings, or any combination thereof that provide a gray tint, brown tint, amber tint, green tint, yellow tint, blue tint, red tint, or any combination thereof configured to filter at least a portion of ambient light 510, stray light 505, or both before the ambient light 510 or stray light 505 reaches the eye 216 of the user. To reduce the likelihood of the second lens 408 filtering at least a portion of output light 615 and causing the brightness of the displayed image represented by output light 615 to be reduced, the tint of the first lens 406, the second lens 408, or both are spatially selective. That is to say, the first lens 406, second lens 408, or both have spatially selective tinting.

For example, referring now to FIG. 8, an isometric view of spatially selective tinting architecture 700 is presented. To achieve spatially selective tinting, a first portion 832 of the second lens 408 includes a tint (e.g., gray tinting, brown tinting, amber tinting, green tinting, yellow tinting, blue tinting, red tinting) from, for example, one or more lenses, dyes, films, coatings, or any combination thereof. Further, a second portion of the second lens 408 includes an aperture 824. Such an aperture 824, for example, includes a portion (e.g., a second portion) of the second lens 408 effectively having no tint such that light passing through the aperture is unimpeded (e.g., unattenuated). In some embodiments, aperture 824 has a shape, position, and size similar to or the same as outcoupler 214 of waveguide 205. As an example, aperture 824 has a same shape and similar size to outcoupler 214 such that output light 615 provided from outcoupler 214 is unimpeded as it passes through the second lens 408 via aperture 824. Additionally, in some embodiments, aperture 824 is disposed at a position on the second lens 408 such that aperture 824 is effectively aligned with outcoupler 214 so as to allow output light 615 provided from outcoupler 214 to be unimpeded as it passes through the second lens 408 via aperture 824. According to embodiments, the second lens 408 further includes a transition region 826 disposed between aperture 824 and the first portion 832 of the second lens 408 including a tint. As an example, transition region 826 includes a portion of the second lens 408 having less tint than the first portion 832 of the second lens 408 having a tint and more tint than aperture 824, a portion of the second lens 408 having a gradient of tint, or both. In this way, the second lens 408 is configured to filter (e.g., attenuate) at least a portion of stray light 505, ambient light 510, or both before stray light 505 or ambient light 510 reaches the eye 216 of a user while allowing output light 615 from outcoupler 214 to pass through unfiltered via aperture 824. Because the output light 615 passes through the second lens 408 without being filtered via aperture 824, glints from stray light 505 reflecting off the surfaces of the waveguide 205 are reduced without reducing the brightness of the display image (e.g., output light 615) provided to the eye 216 of the user by the outcoupler 214 of the waveguide 205.

Further, in some embodiments, spatially selective tinting architecture 700 includes the first lens 406 having a tinted portion 822 that includes at least a portion of the first lens 406 with a tint (e.g., gray tint, brown tint, amber tint, green tint, yellow tint, blue tint, red tint) from, for example, one or more lenses, dyes, films, coatings, or any combination thereof. According to embodiments, tinted portion 822 has a shape, position, and size similar to or the same as aperture 824. For example, tinted portion 822 has a shape, position, and size complementary to aperture 824 such that the second lens 408, optical combiner lens 404, or both appear completely tinted (e.g., an entirety of the second lens 408, optical combiner lens 404, or both appear to be tinted) when the tinted portion 822 is effectively aligned with the aperture 824 (e.g., when the first lens 406, waveguide 205, and second lens 408 are effectively aligned). That is to say, tinted portion 822 has a shape, position, and size complementary to aperture 824 such that aperture 824 is not visible to onlookers of an optical combiner lens (e.g., optical combiner lens 404) implementing spatially selective tinting architecture 700 (e.g., those looking at a user wearing an eyewear display 400 including spatially selective tinting architecture 700). Additionally, the first portion 832 of the second lens 408 and the tinted portion 822 of the first lens 406 together filter (e.g., attenuate) at least a portion of ambient light 510 as if an entirety of the first lens 406, optical combiner lens 404, or both were tinted, helping reduce the number of glints caused by ambient light 510 without reducing the brightness of output light 615 from the outcoupler 214 of the waveguide.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still, further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A spatially selective tinting architecture for a head-worn device (HWD) including:
a frame;
a first lens comprising:
a first portion including a tint; and
a second portion including an aperture; and
a waveguide including an outcoupler configured to provide light to the aperture of the first lens.

2. The spatially selective tinting architecture of claim 1, wherein the aperture is configured to allow the light from the outcoupler to pass through unfiltered.

3. The spatially selective tinting architecture of claim 1, wherein the aperture is a same shape as the outcoupler.

4. The spatially selective tinting architecture of claim 1, wherein at least a portion of the aperture does not include the tint.

5. The spatially selective tinting architecture of claim 1, further comprising:
a second lens comprising a tinted portion, wherein the tinted portion has a same shape as the aperture.

6. The spatially selective tinting architecture of claim 5, wherein the aperture and the tinted portion are aligned.

7. The spatially selective tinting architecture of claim 5, wherein the tinted portion includes the tint.

8. The spatially selective tinting architecture of claim 1, further comprising an optical engine configured to provide laser light to at least a portion of the waveguide.

9. The spatially selective tinting architecture of claim 8, further comprising an arm configured to contain at least a portion of the optical engine.

10. A method, comprising:
emitting, from an optical engine, a laser light toward a waveguide of an optical combiner; and
providing, by an outcoupler of the waveguide, at least a portion of the laser light to a lens of the optical combiner, wherein the lens includes a first portion including a tint and an aperture configured to allow the at least a portion of the laser light to pass through unfiltered.

11. The method of claim 10, wherein the aperture is a same shape as the outcoupler.

12. The method of claim 10, wherein the optical combiner further comprises a second lens comprising a tinted portion, wherein the tinted portion has a same shape as the aperture.

13. The method of claim 12, further comprising:
filtering at least a portion of ambient light based on the tinted portion of the second lens and the first portion of the lens including the tint.

14. The method of claim 12, wherein the tinted portion includes the tint.

15. An optical combiner for a head-worn device (HWD) including:
a first lens comprising:
a first portion including a tint; and
a second portion including an aperture; and
a waveguide including an outcoupler configured to provide light to the aperture of the first lens.

16. The optical combiner of claim 15, wherein the aperture is configured to allow the light from the outcoupler to pass through unfiltered.

17. The optical combiner of claim 15 further comprising:
a second lens comprising a tinted portion, wherein the tinted portion has a same shape as the aperture.

18. The optical combiner of claim 17, wherein the waveguide is disposed between the first lens and the second lens.

19. The optical combiner of claim 17, wherein the tinted portion includes the tint.

20. The optical combiner of claim 17, wherein the tinted portion, aperture, and outcoupler are aligned.
